(19) United States
(12) Patent Application Publication
(10) Pub. No.: US 2007/0218172 A1
(43) Pub. Date: Sep. 20, 2007

(54) Novel brownie casing and packaging system

(76) Inventor: Mark Ballard, Westerville, OH (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/375,423

(22) Filed: Mar. 14, 2006

(51) Int. Cl. A23B 7/148

(52) U.S. Cl. 426/106

(57) ABSTRACT

A packaging system for a plurality of brownies comprising a plurality of stackable disk shaped plastic containers, each of said containers having a bottom disk member for holding a brownie and a top disk member for attachment and a fabric sleeve for holding the plurality of containers.

### FIELD OF THE INVENTION

The present invention is directed to the field of brownie packages. In particular, the present invention is directed to a novel brownie casing and packaging system.

### BACKGROUND OF THE INVENTION

Typically, brownies have been shipped like cookies and cakes in paper or cardboard boxes and containers. This method of packaging and shipping has several problems. Frequently, the brownies packed so get crumbled or mixed with ingredients of other products so packed.

Further, because such packaging is not hermetically sealed, the brownies and other baked goods can dry out and become stale.

Often, expensive brownies are packaged in plastic wrap. This solves the problem of drying out. However, such brownies may be handled by numerous people, leaving finger indentations, which are highly unappetizing. A further problem is that in high temperatures, the brownies will melt and stick to the plastic wrap. This makes for a significant mess.

There are several patents which have been directed to brownies and cookies. U.S. Pat. No. D494,408 dated Aug. 17, 2004 to Hinton et al. discloses ornamental design for a brownie pan.

U.S. Pat. No. 6,228,403 dated May 8, 2001 to Narayanaswamy et al. discloses a ready-to-bake batter article for brownies comprises a gas impermeable container, a low water activity high ratio brownie batter disposed within and partially filling the container and an unpressurized, inert low oxygen gas in the unfilled headspace. The ratio of sugar to flour in the batter ranges from about 1.5:1 to 3.5:1. The batter has a water activity of less than 0.85.

U.S. Pat. No. 6,224,925 dated May 1, 2001 to Narayanaswamy discloses a shelf stable ready-to-bake batter article for brownies comprises an unpressurized gas impermeable container, low water activity high ratio brownie batter disposed within and partially filling the container and an unpressurized, inert low oxygen gas in the headspace. The ratio of sugar to flour in the batter ranges from about 1.5:1 to 3.5:1. The batter has a water activity of less than 0.85.

Heretofore, there has been no packaging system for brownies which protect the brownie and maintain freshness and product integrity. It would be desirable to provide a packaging container and packaging system which could provide freshness and protect the product from damage. It would be further desirable to provide a packaging system for storing and shipping a plurality of brownies.

It is an object of the present invention to provide a novel packaging container for fresh brownies.

It is an object of the present invention to provide a packaging container for brownies which maintains moisture and freshness and which prevents damage.

It is a further description of the present invention to provide a system which is a novel brownie package to be nested and placed in a package.

It is still a further object of the present invention to provide a packaging system whereby brownies can be hermetically sealed and packaged.

### SUMMARY OF THE INVENTION

In accordance with the invention, the invention discloses a container for holding a food product comprising a disk shaped container having a bottom casing for holding the product and a sealed disk shaped cover for hermetically sealing the container.

In a further embodiment of the present invention, the invention discloses a container for holding a brownie comprising an acrylic disk shaped container having a bottom casing for holding the brownie; a top disk shaped member for attaching to and sealing the bottom member and a wrapper for wrapping the brownie within the container.

In still a further embodiment, this invention discloses a packaging system for a plurality of brownies comprising a plurality of stackable disk shaped plastic containers, each of said containers having a bottom disk member for holding a brownie and a top disk member for attachment and a fabric sleeve for holding the plurality of containers.

In yet still a further embodiment, this invention discloses a container for holding a brownie comprising an acrylic disk shaped container having a bottom casing for holding the brownie; a top disk shaped member for attaching to and sealing the bottom member; a wrapper for wrapping the brownie within the container and a seal for sealing the container.

### DESCRIPTION OF THE FIGURES

FIG. 1 is an overhead view of the novel brownie casing of the present invention.

FIG. 2 is a side view of the brownie casing of the present invention.

FIG. 3 is an overhead broken casing view of the case of the present invention.

FIG. 4 is an exploded view of the case of the present invention.

FIG. 5 illustrates a nested casing in accordance with the invention.

FIG. 6 illustrates a nested brownie casing in a sack.

FIG. 7 illustrates the novel casing in a tied sack.

### BRIEF DESCRIPTION OF THE PREFERRED EMBODIMENT

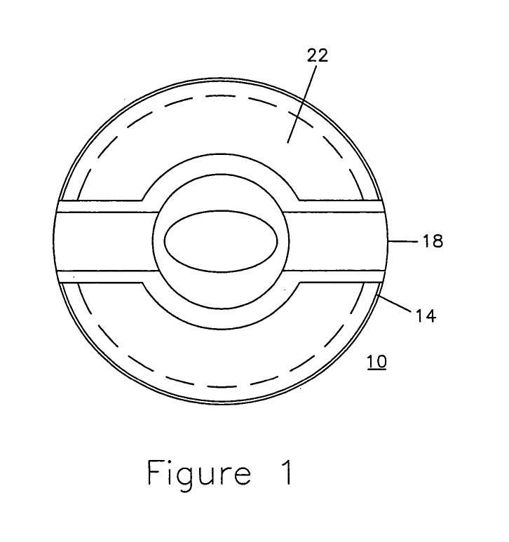

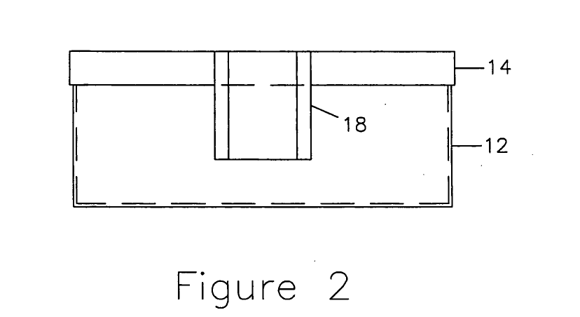

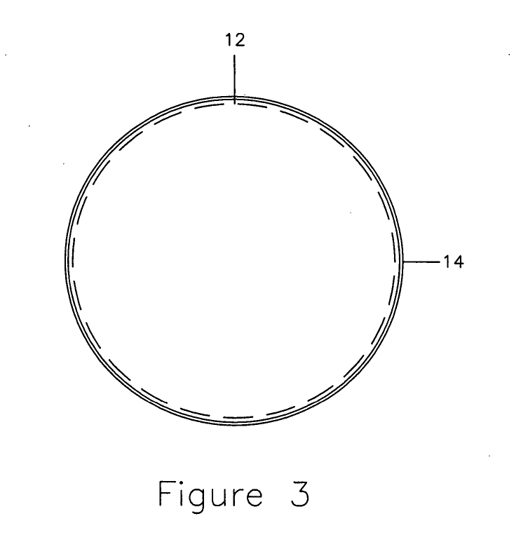

The present invention is described with reference to the enclosed Figures wherein the same numbers are used where applicable. Referring to FIGS. 1-4, the invention as shown is a casing 10 and packaging system. The present invention in a first embodiment comprises a casing 10 to hold and support an individualized cake portion such as a brownie and specifically, a round edgeless brownie. While the present invention is described with reference to a brownie, it is to be appreciated that the technology of the invention is applicable to a wide variety of cakes, cookies and baked confections.

Referring to the Figures in a preferred embodiment, the casing 10 comprises of a disk shaped casing or container having a bottom holding section 12 and a snap on lid 14. The affixation of the lid 14 provides a tight seal. The seal locks in the moisture and freshness of the brownie. The casing will preferably be secured by a paper seal 18. The paper seal 18 provides a tamper proof assurance that the casing has not been opened.

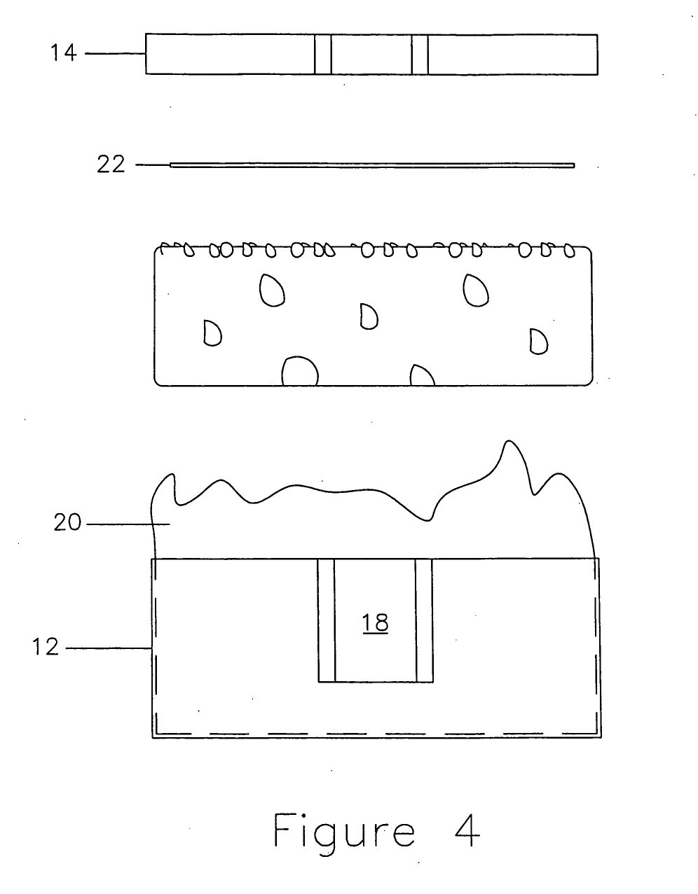

As shown in the preferred embodiment of FIG. 4, the invention includes the casing bottom. There is a piece of wrapping paper 20 which surrounds the brownie and wrap. An information card 22 is placed on top of the wrapped brownie, which provides advertising and nutritional information.

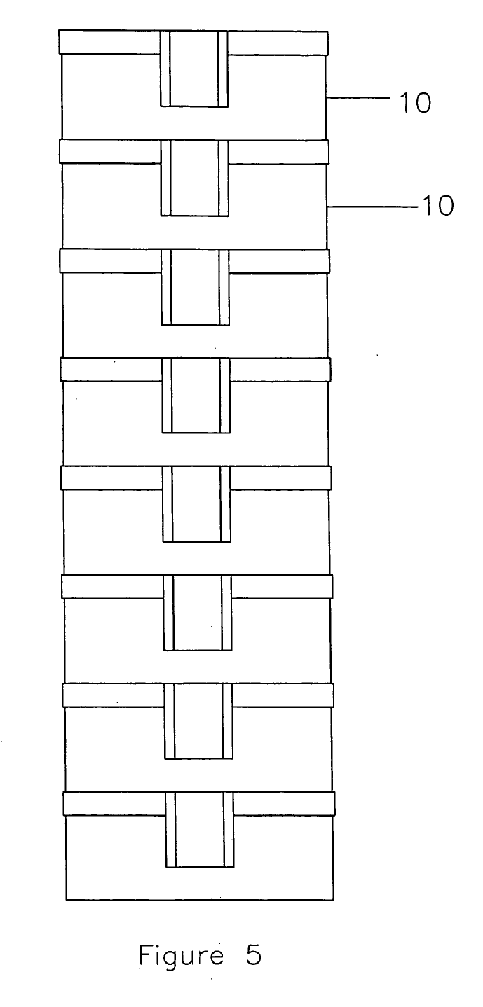

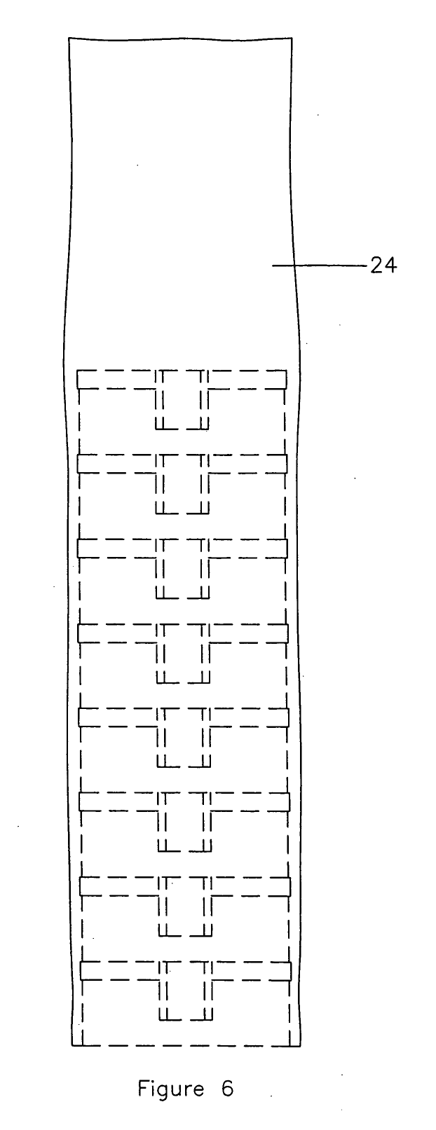

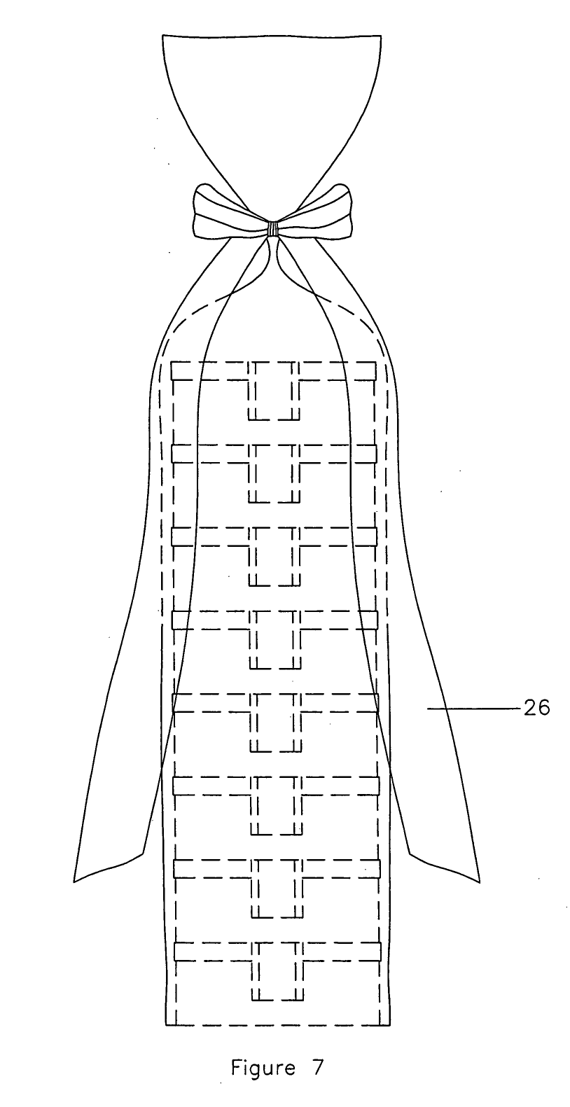

FIG. 5 illustrates that a plurality of casings 10 can be stacked vertically for handling and storage. FIGS. 6 and 7 illustrate an embodiment in which the stacked casings can be placed in an elongate bag or sack 24. The sack 24 may be constructed from silk, a synthetic fabric or cotton and tied with a ribbon 26.

The present invention has been described with reference to the above discussed preferred embodiment. The true nature and scope of the invention is to be determined with reference to the claims appended hereto.

1. A container for holding a food product comprising:
a disk shaped container having a bottom casing for holding the product; and
a sealed disk shaped cover for hermetically sealing the container.

2. A container for holding a brownie comprising:
an acrylic disk shaped container having a bottom casing for holding the brownie;
a top disk shaped member for attaching to and sealing the bottom member; and
a wrapper for wrapping the brownie within the container.

3. A packaging system for a plurality of brownies comprising:
a plurality of stackable disk shaped plastic containers, each of said containers having a bottom disk member for holding a brownie and a top disk member for attachment; and
a fabric sleeve for holding the plurality of containers.

4. The packaging system of claim 3 wherein the fabric sleeve is constructed from silk.

5. The packaging system of claim 3 wherein the fabric sleeve is constructed from a synthetic fabric.

6. The packaging system of claim 3 wherein the fabric sleeve is constructed from cotton.

7. A container for holding a brownie comprising:
an acrylic disk shaped container having a bottom casing for holding the brownie;
a top disk shaped member for attaching to and sealing the bottom member;
a wrapper for wrapping the brownie within the container; and
a seal for sealing the container.
